(19) United States
(12) Patent Application Publication
(10) Pub. No.: US 2006/0126949 A1
(43) Pub. Date: Jun. 15, 2006

(54) Method of coding and decoding still picture

(75) Inventors: Jin Soo Lee, Seoul (KR); Min Sub Kim, Seoul (KR); Byoung Su Kang, Seongnam-si (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/302,748

(22) Filed: Dec. 13, 2005

(30) Foreign Application Priority Data
Dec. 14, 2004 (KR) 10-2004-0105723

(51) Int. Cl. G06K 9/36

(52) U.S. Cl. 382/232

(57) ABSTRACT

A method of coding and decoding a still picture is provided. The method of coding and decoding a still image includes: constructing a coded data configured with a region consisting of a first information expressible in bit and a second information expressible in byte by using separate output buffers; and separately allocating a first output buffer for the first information and a second output buffer for the second information, and decoding the coded data.

This application claims the benefit of the Korean Patent Application No. 10-2004-0105723, filed on Dec. 14, 2004, which is hereby incorporated by reference as if fully set forth herein.

### BACKGROUND OF THE INVENTION

1. Field of the Invention

The present invention relates to a method of coding and decoding still picture.

2. Description of the Related Art

Various kinds of mobile terminals have been provided. Although the mobile terminals get miniaturized, the resolution of screen is increasing and the number of colors expressible per pixel is increasing. Also, high-quality displays tend to be mounted.

In the mobile terminals, user interface (UI) is developed toward three-dimensional image and animation UI, as well as simple image. Accordingly, there is an increasing demand for memory space for recording an image stored in the mobile terminal and playing it for the user interface. Developments of a dedicated compression codec for picture of the UI are actively in progress.

Specifically, an image codec for UI picture requires a fast decoding speed. Most pictures of the UI have to be display immediately when the user presses buttons. Therefore, in decoding an image stored for UI, a delay time that the user feels has to be minimized. The image has to be decoded and displayed fast as the user cannot feel the delay time. In most cases, the decoding and display have to be completed within 100 ms. For most of the mobile phones, for example a portable phone, a low-performance central processing unit (CPU) such as an advanced RISC machine 7 (ARM7) and ARM9 controls the UI and thus it is difficult to use a codec such as JPEG having a large amount of computation.

Therefore, a BITMAP that is an original data is used in the UI picture. Since the BITMAP does not perform a compression operation, a large-capacity memory is required. A codec having a compression ratio ranging from ½ up to ⅕ with respect to an original data is used as a codec dedicated to a UI picture. This codec is an applied method of a dictionary based codec such as Lempel Zip Welch (LZW). Although this codec has a very fast decoding speed, a compression ratio ranges from ½ up to ⅕ with respect to the original data. The most important requirement of the codec dedicated to the UI picture is a fast decoding speed as well as the compression ratio. Accordingly, even in the same compression algorithm, the technology development to enable the encoding and decoding process to be processed according to the CPU is required.

A following dictionary based codec is used as an image codec that stores a compressed UI in the mobile terminal and decodes it. FIG. 1 illustrates a concept of a related art dictionary based codec. The dictionary based codec is a method to encoding a portion to be currently encoded by referring to a previously encoded portion. Referring to FIG. 1, a portion to be currently encoded is encoded by referring to N number of previously encoded data spaced apart from a position to be currently encoded by a predetermined distance D. If the matching number of the portion to be currently encoded and the previously encoded portion is less than a preset reference value, the current pixel value is encoded. If the matching number is greater than the reference value, the coding is performed while the distance D from the portion to be currently encoded to the position where the matching starts, and the matching number N are encoded.

In the dictionary based codec, the codec related information includes an information as to whether the matching exists or not, a pixel value, the matching number N and distance D. The information related to the existence of the matching can be expressed in bit and have a header region. The pixel value is an information that can be expressed in byte and have a data region. The matching number N and the distance D are information requiring bit and byte.

The dictionary based codec codes a still picture using one output buffer. FIG. 2 is a diagram of the output buffer, showing a dictionary based codec method of coding a still picture using one output buffer. One output buffer is designated during a coding process, and an encoding is performed while using a header pointer and a data pointer. FIG. 3 is a diagram illustrating a result of a bitstream coded by the dictionary based codec using one output buffer. Referring to FIG. 3, the header and the data are alternately used in one output buffer. That is, the header and the data are alternately stored. The method of alternately using the header and the data in one output buffer does not cause problems in PC-like environment. However, such a method causes problems in an environment with restricted memory and resource such as a mobile terminal.

That is, when the header and the data are repeatedly stored in one output buffer, positions of pointers where a next header and a next data are located have to be calculated each time. Also, it is necessary to access the memory based on one header and data. Consequently, the number of times of memory access increases and the decoding speed is degraded. Specifically, in the case of the ARM that is widely used as a processor in the mobile terminal, these factors will degrade the decoding and display speed of UI picture. Thus, there is a demand for a technology that has a fast decoding and display speed even when the dictionary based codec is applied in a field requiring a fast decoding speed, such as a UI picture of a mobile terminal.

### SUMMARY OF THE INVENTION

Accordingly, the present invention is directed to a method of coding and decoding still picture that substantially obviate one or more problems due to limitations and disadvantages of the related art.

An object of the present invention is to provide a method of coding and decoding still picture, which can reduce the number of times of memory access and code and decode an image data at a small amount of computation.

Another object of the present invention is to provide a method of coding and decoding still picture, which can be applied to a UI codec requiring a fast coding speed by decoding an image data coded at a small number of times of memory access and a small amount of computation.

A further another aspect of the present invention is to provide a method of coding and decoding still image, which can be applied to a UI codec requiring a fast coding performance by modifying a coding stream structure. In the method, an amount of computation for pointer calculation is reduced, the number of memory access is reduced, and the still image data can be processed by a simple consecutive shifting operation, thereby providing a fast decoding speed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of coding a still picture, including: coding a first information expressible in bit and a second information expressible in byte by using separate output buffers; and constructing coding data steam separately in each region of the coded information.

In another aspect of the present invention, there is provided a method of decoding a still picture, including: separately allocating a first output buffer of a first information expressible in bit and a second output buffer of a second information expressible in byte in a coded image data; and decoding data stored in the second output buffer according to an information obtained in the first output buffer.

According to the present invention, the picture can be fast displayed by coding and decoding UI pictures such as a background picture and icon in a mobile phone, and a memory space can also be reduced. The case of using a 16-bit external bus and the case of using a 32-bit external bus can be designed in ARM and can be selectively applied. The present invention can be applied to other codec as well as the ARM. Further, a decoder having the fast decoding and display performance can be implemented by reducing the number of times of memory access.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a concept of a related art dictionary based codec;

FIG. 2 is a diagram illustrating a dictionary based codec method of coding a still picture using one output buffer;

FIG. 3 is a diagram illustrating a result of a bitstream coded by the dictionary based codec using one output buffer;

FIG. 4 is a diagram for explaining a method of coding and decoding still picture according to an embodiment of the present invention;

FIG. 5 is a diagram of a register structure when a 16-bit external bus is used; and

FIG. 6 is a diagram of a register structure when a 32-bit external bus is used.

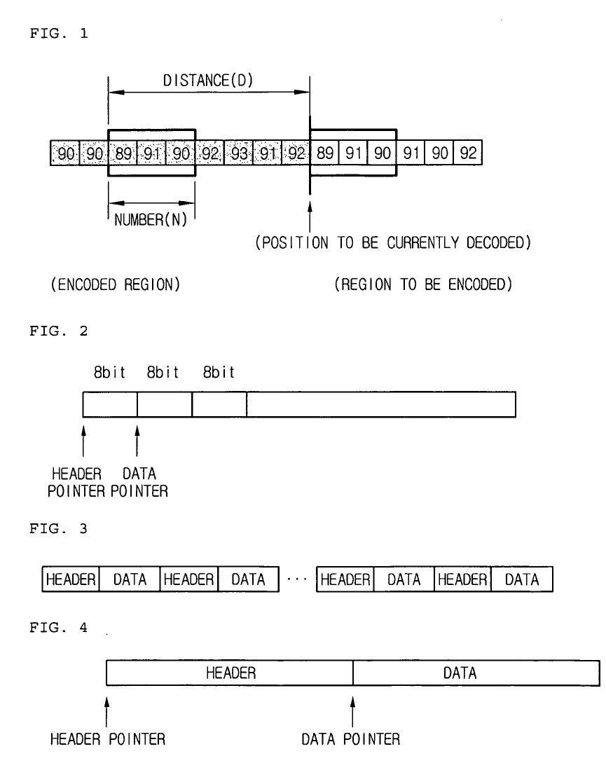

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

FIG. 4 is a diagram of an output buffer structure, illustrating a method of coding and decoding still picture according to an embodiment of the present invention. Referring to FIG. 4, a header region and a data region are separately coded in the output buffer. That is, in coding an input image, a coded result includes a first information (the header region) that can be expressed in bit, and a second information (the data region) that can be expressed in byte. The first information and the second information are separately coded in the output buffer. A coding process is performed through the output buffer in which data of the header information region (the coded result is configured in bit) and data of the data information region (the coded result is configured in byte) are separately provided.

The data of the header information region and the data of the data information region are coded using a dictionary based codec that expresses repetitive patterns are expressed with a dictionary index. In this manner, the data coded using the output buffer construct a coding data bitstream such that they are separated in different regions.

The coded data is constructed with the header region where the coded result is expressed in bit and the data region where the coded result is expressed in byte. The data of the header information region and the data of the data information region are decoded using the separate output buffers.

In decoding the data, corresponding bits of the header information region are consecutively read and expressed. In this manner, the data of the header information region can be loaded on a header processing register and processed at a time. Consequently, memory access time and the number of times of memory access can be reduced. The data of the data information region are loaded on a data processing register and processed at a time. If the dictionary based codec is applied, a decoding of a current pixel or a decoding that refers to N number of previously encoded portion spaced apart by a distance D can be selected according to the information related to the presence of the matching, which is the information that can be expressed in bit.

According to this codec, a codec design can be achieved in both the case of using the 16-bit external bus in the ARM and the case of using the 32-bit external bus. The case of using the 16-bit bus and the case of using the 32-bit external bus can be selectively applied.

An ARM processor is a processor widely used in the mobile terminal and its kinds are various. The ARM processor can perform 16-bit or 32-bit data communication with the exterior according to its kinds and implementation methods. Software operating on the ARM processor can be classified into ARM code and thumb code. It is known that the thumb code is (about 130%) faster than the ARM code when the 16-bit external bus is used. In this case, thumb command is created. It is known that the ARM code is (about 40%) faster than the thumb code when the 32-bit external bus is used. In this case, ARM command is created.

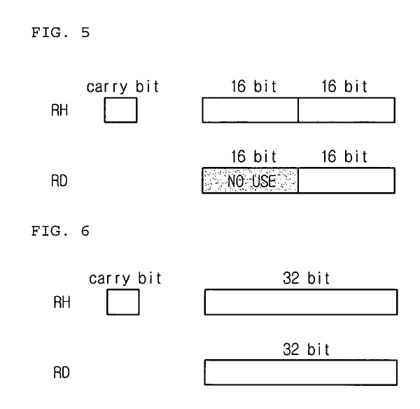

FIG. 5 is a diagram of a register structure when the 16-bit external bus is used. Specifically, the register includes a register RH reading the header region and a register RD reading a data region. When the 16-bit external bus is used, a register of a decoder for decoding a coded still image data is separately provided with an internal register RH for processing the header information and an internal register RD for processing the data information. The internal register RH loads a coded data of the header information region and the internal register RD loads a coded data of the data information region.

Also, the decoder further includes a parser that selects a decoding method by checking a carry bit while continuously shifting the upper 16 bits by one bit after the lower 16 bits of the internal register RD are shifted to the upper 16 bits. In addition, the decoder includes a data processor that reads the lower 16 bits of the data information region inputted to the internal register RD by 8-bit unit and decodes them according to the selected decoding method.

The decoding process of the coded still image data when the 16-bit external bus is used will be described below. Since the thumb command basically executes a 16-bit processing, a one-time load command fills the lower 16 bits of the registers RH and RD. In the case of the data of the header information region, the loaded lower 16 bits are shifted to the upper 16 bits and then processed. The carry bit is checked while continuously shifting the data of the header information region shifted to the upper 16 bits one bit by one bit. A decoding method is selected according to the method expressed by the checked carry bit. The header information region can be parsed rapidly and decoded.

In the case of the data of the data information region, the lower 16 bits of the register RD are used. The data of the data information region are read one pixel (8 bits) by one pixel and the corresponding data is decoded according to the decoding method selected according to the parsing result of the data of the header region.

The decoding process of the coded still image data when the 32-bit external bus is used will be described below. In the case of using the 32-bit external bus, the ARM is faster by 40% compared with the case of using the 16-bit external bus. Using this characteristic, the ARM command is created.

FIG. 6 is a diagram of a register structure when the 32-bit external bus is used. Specifically, the register includes a register RH reading the header region and a register RD reading a data region.

When the 32-bit external bus is used, a register of a decoder for decoding a coded still image data is separately provided with an internal register RH for processing the header information and an internal register RD for processing the data information. The internal register RH loads a coded data of the header information region and the internal register RD loads a coded data of the data information region.

Also, the decoder further includes a parser that selects a decoding method by checking a carry bit while continuously shifting data of the internal register RH by one bit. In addition, the decoder includes a data processor that takes the 32 bits of the data information region inputted to the internal register RD, reads them by 8-bit unit, and decodes them according to the selected decoding method.

Since the ARM command basically executes a 32-bit processing, a one-time load command fills the 32 bits of the registers RH and RD. In the case of the data of the header information region, a carry bit is checked while continuously shifting the data of the header information region one bit by one bit. A decoding method is selected according to the method expressed by the checked carry bit. The data of the header information region can be parsed rapidly and decoded.

In the case of the data of the data information region, the 32 bits of the register RD are used. The data of the data information region are read one pixel (8 bits) by one pixel and the corresponding data is decoded according to the decoding method selected according to the parsing result of the data of the header region.

An entire system to which the method of coding and decoding still picture according to the present invention is applied can selectively use the case of using the 16-bit external bus and the case of using the 32-bit external bus in the ARM, and can design and implement the codec.

Also, the buffer of the header information region to be decoded and the buffer of the data information region are separately provided. In the case of the header information region, the data are loaded on the register at a time and the decoding method can be selected while reading the data one bit by one bit. Consequently, the memory access time can be reduced. Further, a time taken to decode and display the coded data is shortened, thereby playing the still image rapidly.

It will be apparent to those skilled in the art that various modifications and variations can be made in the present invention. Thus, it is intended that the present invention covers the modifications and variations of this invention provided they come within the scope of the appended claims and their equivalent.

What is claimed is:

1. A method of coding a still picture, comprising:
coding a first information expressible in bit and a second information expressible in byte by using separate output buffers; and
constructing coding data steam separately in each region of the coded information.

2. The method according to claim 1, wherein the coding is performed using a dictionary based codec.

3. The method according to claim 1, wherein the first information is included in a header region.

4. The method according to claim 1, wherein the second information is included in a data region.

5. The method according to claim 1, wherein the first information includes an information that expresses an existence of a matching in a dictionary based codec algorithm.

6. The method according to claim 1, wherein the second information is a pixel value in a dictionary based codec algorithm.

7. The method according to claim 1, wherein the coding is performed using a dictionary based codec, and an information on number of a matching and an information on a matching distance are included as an information that is expressible both in bit and in byte.

8. The method according to claim 1, wherein the coding processor is based on an advanced RISC machine (ARM).

9. A method of decoding a still picture, comprising:
separately allocating a first output buffer of a first information expressible in bit and a second output buffer of a second information expressible in byte in a coded image data; and
decoding data stored in the second output buffer according to an information obtained in the first output buffer.

10. The method according to claim 9, wherein the image data is coded based on a dictionary based codec.

11. The method according to claim 9, wherein the first information is included in a header region.

12. The method according to claim 9, wherein the second information is included in a data region.

13. The method according to claim 9, wherein the first information includes an information that expresses an existence of a matching in a dictionary based codec algorithm.

14. The method according to claim 9, wherein the second information is a pixel value in a dictionary based codec algorithm.

15. The method according to claim 9, wherein the coding is performed using a dictionary based codec, and an information on number of a matching and an information on a matching distance are included as an information that is expressible both in bit and in byte.

16. The method according to claim 9, wherein the decoding processor is based on an advanced RISC machine (ARM).

17. The method according to claim 9, wherein the decoding process comprises:
storing a data in the first output buffer;
selecting a decoding scheme according to a carry bit while shifting the data; and
decoding data stored in the second output buffer according to the selected decoding scheme.

18. A method of coding and decoding a still image, comprising:
constructing a coded data configured with a region consisting of a first information expressible in bit and a second information expressible in byte by using separate output buffers; and
separately allocating a first output buffer for the first information and a second output buffer for the second information, and decoding the coded data.

19. The method according to claim 18, wherein the first information is a header information including an information expressing an existence of a matching in a dictionary based codec, the second information is a corresponding pixel value in the dictionary based codec, and an information on number of a matching and an information on a matching distance are included as an information that is expressible both in bit and in byte.

20. The method according to claim 18, wherein the decoding process comprises:
storing a data in the first output buffer;
selecting a decoding scheme according to a carry bit while shifting the data; and
decoding data stored in the second output buffer according to the selected decoding scheme.
